(19) United States
(12) Patent Application Publication
(10) Pub. No.: US 2026/0021718 A1
(43) Pub. Date: Jan. 22, 2026

(54) Electric Vehicle and Method of Controlling Rapid Charging of Electric Vehicle

(71) Applicants: HYUNDAI MOTOR COMPANY, Seoul (KR); KIA CORPORATION, Seoul (KR)

(72) Inventor: Tae Hwan Kang, Hwaseong-si (KR)

(73) Assignees: HYUNDAI MOTOR COMPANY, Seoul (KR); KIA CORPORATION, Seoul (KR)

(21) Appl. No.: 19/008,418

(22) Filed: Jan. 2, 2025

(30) Foreign Application Priority Data
Jul. 18, 2024 (KR) 10-2024-0095035

(51) Int. Cl. B60L 53/10

(52) U.S. Cl. CPC B60L 53/11; B60L 2210/12

(57) ABSTRACT

An electric vehicle includes a battery, a motor, an inverter, a mode change switch, and a control module. The control mode includes one or more processors, and a storage medium storing a computer-readable instruction. When the computer-readable instruction is executed by one or more processors, the one or more processors are configured to determine a rapid charging mode according to a connected charging facility, the rapid charging mode including a first rapid charging mode when the charging facility is a DC distribution network facility and a second rapid charging mode when the charging facility is a rapid charging facility, and to control, based on a result of the determination, the mode change switch to change from the first rapid charging mode to the second rapid charging mode or from the second rapid charging mode to the first rapid charging mode.

### CROSS-REFERENCE TO RELATED APPLICATION(S)

This application claims the benefit of priority to Korean Patent Application No. 10-2024-0095035 filed on Jul. 18, 2024, in the Korean Intellectual Property Office, the disclosure of which is incorporated herein by reference in its entirety.

### TECHNICAL FIELD

The present disclosure relates to an electric vehicle and a method of controlling rapid charging of an electric vehicle.

### BACKGROUND

A rapid charging facility may (e.g., directly) charge a battery mounted in an electric vehicle by supplying DC power to the electric vehicle. The rapid charging facility may rectify input AC to form a DC voltage and subsequently (e.g., directly) charge the electric vehicle through a DC/DC converter using a high-frequency isolation transformer.

Accordingly, in order to charge a plurality of vehicles, a rapid charging facility may be used for each of the plurality of vehicles, and an AC distribution cable may be connected to each rapid charging facility.

### SUMMARY

An aspect of the present disclosure provides an electric vehicle and a rapid charging control method capable of reducing costs for installation of a charging facility and may be compatible with an existing rapid charging facility.

According to an aspect of the present disclosure, there is provided an electric vehicle including a battery, a motor, an inverter, a mode change switch, and a control module. The control mode may include one or more processors, and a storage medium storing a computer-readable instruction. When the computer-readable instruction is executed by one or more processors, the one or more processors may be configured to determine a rapid charging mode according to a connected charging facility, the rapid charging mode including a first rapid charging mode when the charging facility is a DC distribution network facility and a second rapid charging mode when the charging facility is a rapid charging facility, and to control, based on a result of the determination, the mode change switch to change from the first rapid charging mode to the second rapid charging mode or from the second rapid charging mode to the first rapid charging mode.

The mode change switch may be a three-way switch. A first terminal and a second terminal of the three-way switch may be connected between a (+) terminal of the battery and the inverter. A third terminal of the three-way switch may be connected to a neutral point of a stator coil included in the motor.

The one or more processors may be configured to perform, based on a flag received from the connected charging facility, the determination.

When the rapid charging mode is the first rapid charging mode, the one or more processors may be configured to control the mode change switch to disconnect the (+) terminal of the battery and the inverter from each other, and to connect the (+) terminal of the battery to the neutral point of the stator coil included in the motor.

The electric vehicle may further include a pair of relays on an EV side provided on an input side. The one or more processors may be configured to turn on the pair of relays on the EV side.

The one or more processors may be configured to drive the inverter as a buck converter in the first rapid charging mode.

The buck converter may include three buck converters, rapidly charging the battery, using three stator coils included in the motor as inductors in the first rapid charging mode.

The buck converter may include a first buck converter including a pair of switching elements included in a first leg of the inverter, and a first stator coil included in the motor, a second buck converter including a pair of switching elements included in a second leg of the inverter, and a second stator coil included in the motor, and a third buck converter including a pair of switching elements included in a third leg of the inverter, and a third stator coil included in the motor.

The one or more processors may be configured to drive one of the first buck converter, the second buck converter, and the third buck converter in the first rapid charging mode, to (e.g., substantially) simultaneously drive at least two of the first buck converter, the second buck converter, and the third buck converter in the first rapid charging mode, and to drive at least two of the first buck converter, the second buck converter, and the third buck converter in an interleaved manner in the first rapid charging mode.

When the rapid charging mode is the second rapid charging mode, the one or more processors may be configured to control the mode change switch to connect the (+) terminal of the battery to the inverter.

The electric vehicle may further include a pair of relays on an EV side provided on an input side. The one or more processors may be configured to turn on the pair of relays on the EV side.

The DC distribution network facility may include a three-winding transformer configured to convert three-phase AC power into first AC power according to Y-Y connection, and to convert the three-phase AC power into second AC power through Y-Delta connection, a first rectifier configured to rectify the converted first AC power, and a second rectifier configured to rectify the converted second AC power. An output of the first rectifier and an output of the second rectifier may be connected to each other in parallel.

One electric vehicle may be connectable to the rapid charging facility. A plurality of electric vehicles may be connectable to the DC distribution network facility.

According to another aspect of the present disclosure, there is provided a method of controlling rapid charging of an electric vehicle including a motor, a battery, an inverter, and a mode change switch. The method includes a first operation of determining a rapid charging mode according to a connected charging facility, the rapid charging mode including a first rapid charging mode when the charging facility is a DC distribution network facility and a second rapid charging mode when the charging facility is a rapid charging facility, and a second operation of controlling, based on a result of the determination, the mode change switch to change from the first rapid charging mode to the second rapid charging mode or from the second rapid charging mode to the first rapid charging mode.

The mode change switch may be a three-way switch. A first terminal and a second terminal of the three-way switch may be connected between a (+) terminal of the battery and the inverter. A third terminal of the three-way switch may be connected to a neutral point of a stator coil included in the motor.

The first operation may include performing, based on a flag received from the connected charging facility, the determination.

When the rapid charging mode is the first rapid charging mode, the second operation may include controlling the mode change switch to disconnect the (+) terminal of the battery and the inverter from each other, and to connect the (+) terminal of the battery to the neutral point of the stator coil included in the motor. When the rapid charging mode is the second rapid charging mode, the second operation may include controlling the mode change switch to connect the (+) terminal of the battery to the inverter.

The method may further include an operation of driving the inverter as a buck converter in the first rapid charging mode. The buck converter may include three buck converters, rapidly charging the battery, using three stator coils included in the motor as inductors in the first rapid charging mode.

The method may further include an operation of driving one of the first buck converter, the second buck converter, and the third buck converter in the first rapid charging mode, an operation of (e.g., substantially) simultaneously driving at least two of the first buck converter, the second buck converter, and the third buck converter in the first rapid charging mode, and an operation of driving at least two of the first buck converter, the second buck converter, and the third buck converter in an interleaved manner in the first rapid charging mode.

A plurality of electric vehicles may be connectable to the DC distribution network facility in parallel. One electric vehicle may be connectable to the rapid charging facility.

According to an example embodiment of the present disclosure, a rapid charging mode according to a connected charging facility may be determined, and a mode change switch may be controlled based on a result of the determination to allow change between rapid charging modes, such that a plurality of electric vehicles may be charged through a single large-capacity DC distribution network facility, thereby reducing costs for installation of a charging facility and being compatible with an existing rapid charging facility.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1A is a diagram illustrating a DC distribution network facility according to an example embodiment of the present disclosure;

FIG. 1B is a diagram illustrating a rapid charging facility according to an example embodiment of the present disclosure;

FIG. 2 illustrates an electric vehicle connected to a DC distribution network facility among charging facilities according to an example embodiment of the present disclosure;

FIG. 3 is a diagram illustrating three buck converters;

FIG. 4 is a flowchart illustrating a method of controlling rapid charging of an electric vehicle according to an example embodiment of the present disclosure; and

FIG. 5 is a block diagram of a computing device capable of fully or partially implementing a control module of an electric vehicle according to an example embodiment of the present disclosure.

### DETAILED DESCRIPTION

Hereinafter, specific example embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the example embodiments of the present disclosure, when it is determined that a detailed description of a known technology related to the present disclosure may obscure the gist of the present disclosure, the detailed description thereof will be omitted. In addition, terms to be described later are terms defined in consideration of functions in the present disclosure, which may vary depending on the intention or custom of a user or operator. Therefore, the definition of these terms should be made based on the contents throughout the present specification. The terminology used herein is for the purpose of describing particular example embodiments (e.g., only) and is not to be limiting of the example embodiments. As used herein, the singular forms “a,” “an,” and “the” are intended to include the plural forms as well, unless the context clearly indicates otherwise. As used herein, the term “and/or” includes any combination of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

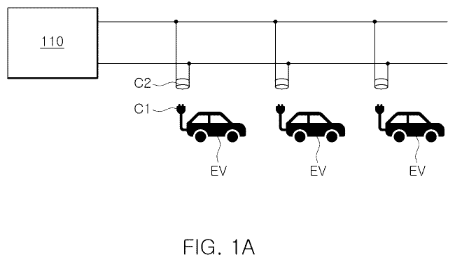

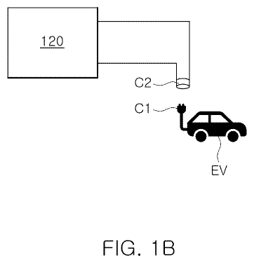

FIG. 1A is a diagram illustrating a DC distribution network facility according to an example embodiment of the present disclosure. FIG. 1B is a diagram illustrating a rapid charging facility according to an example embodiment of the present disclosure.

First, as illustrated in FIG. 1A, a DC distribution network facility 110 may be a large-capacity charging facility, and a plurality of electric vehicles EV may be (e.g., substantially) simultaneously connected to the DC distribution network facility 110 and charged.

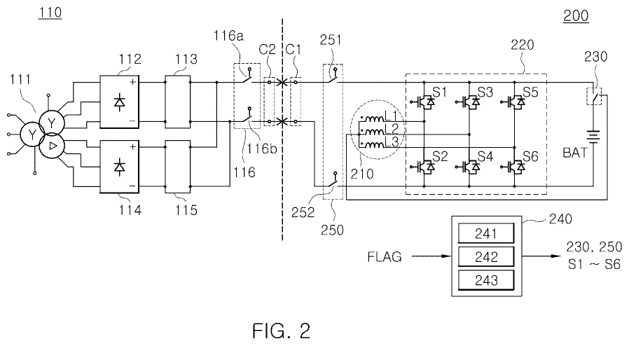

As illustrated on the left side of FIG. 2, the DC distribution network facility 110 may include three-phase AC power to first AC power according to Y-Y connection, a three-winding transformer 111 converting the three-phase AC power into second AC power through Y-Delta (Y-A) connection, a first rectifier 112 rectifying the converted first AC power, and a second rectifier 114 rectifying the converted second AC power, and an output of the first rectifier 112 and an output of the second rectifier 114 may be connected to each other in parallel. A DC high voltage of about 1000 V may be provided through the DC distribution network facility 110. In some example embodiments, power factor improvement circuits 113 and 115 may be further provided in outputs of the rectifiers 112 and 114, respectively.

In addition, a relay module 116, including a pair of relays 116a and 116b, and a connector C2 may be provided on an output side of the DC distribution network facility 110. The connector C2 may be connected to a connector C1 provided on a side of an electric vehicle EV. In general, the connector C2 may be referred to as an outlet and the connector C1 may be referred to as an inlet.

As illustrated in FIG. 1B, (e.g., only) one electric vehicle EV may be connected to a rapid charging facility 120 and charged. The rapid charging facility 120 may include a DC/DC converter (not illustrated) using a rectifying unit and a high-frequency isolation transformer, and may rectify a three-phase AC power of about 400 V to form a DC voltage of about 100 V to about 1000 V through the rectifying unit. Thereafter, the rapid charging facility 120 may (e.g., directly) charge an electric vehicle through the DC/DC converter. Although not illustrated in the drawings, the relay module 116 and the connector C2 may be provided on an output side of the rapid charging facility 120.

FIG. 2 illustrates an electric vehicle connected to a DC distribution network facility, among charging facilities, according to an example embodiment of the present disclosure. Although not illustrated, a rapid charging facility may be connected in the same manner through a relay module and a connector.

In the present disclosure, the electric vehicle may include a high-voltage battery charged by the charging facilities 110 and/or 120, and may include a plug-in hybrid electric vehicle (PHEV) in addition to a pure electric vehicle.

As illustrated on the right side of FIG. 2, an electric vehicle 200 may include a battery BAT, a motor 210, an inverter 220, a mode change switch 230, a control module 240, a connector C1, and a relay or relay module 250 having a pair of relays 251 and 252.

The connector C1 may be connected to the connector C2 of the charging facilities 110 and/or 120, and the relay 250 may connect the electric vehicle 200 to the charging facilities 110 and/or 120 or disconnect the electric vehicle 200 from the charging facilities 110 and/or 120 under the control of the control module 240.

The battery BAT may be a high-voltage battery that may supply power to the motor 210 or may be charged using power supplied from the charging facilities 110 and/or 120.

Under the control of the control module 240, the inverter 220 may convert power of the battery BAT into three-phase power in a driving mode to drive the motor 210 of the electric vehicle 200, and the battery BAT may be charged using DC power supplied from the charging facilities 110 and/or 120 in a rapid charging mode.

Here, the rapid charging mode may include a first rapid charging mode when the charging facility is the DC distribution network facility 110, and a second rapid charging mode when the charging facility is the rapid charging facility 120.

As illustrated in FIG. 2, the mode change switch 230 may be a three-way switch, a first terminal and a second terminal of the three-way switch may be connected between a (+) terminal of the battery BAT and the inverter 220, and a third terminal of the three-way switch may be connected to a neutral point of stator coils L1, L2, and L3 included in the motor 210.

The control module 240 may control the mode change switch to change from the first rapid charging mode to the second rapid charging mode or from the second rapid charging mode to the first rapid charging mode according to the connected charging facilities 110 and/or 120. The control module 240 may include an input/output unit 241, a control unit 242, and a storage unit 243.

The above-described control module 240 may include a processor (for example, a computer, a microprocessor, a CPU, an ASIC, a logic circuit, or the like), and a memory storing software instructions providing various functions when executed by the processor. Here, the processor and the memory may be implemented by separate semiconductor circuits. Alternatively, the processor and the memory may be implemented by a single integrated semiconductor circuit. One or more processors may be provided.

Specifically, when the charging facilities 110 and/or 120 are connected, the input/output unit 241 may receive a flag signal from the charging facilities 110 and/or 120 through communication and then transmit the received flag signal to the control unit 242.

The control unit 242 may determine, based on the flag signal received from the charging facilities 110 and/or 120, the rapid charging mode. For example, when the charging facility is the DC distribution network facility 110, the flag signal may be “1,” and when the charging facility is the rapid charging facility, the flag signal may be “0.”

When the rapid charging mode is the first rapid charging mode, the control unit 242 may control the mode change switch 230 to disconnect the (+) terminal of the battery BAT and the inverter 220 from each other, and may connect the (+) terminal of the battery BAT to the neutral point of the stator coils L1, L2, and L3 included in the motor 210.

Separately, the control unit 242 may turn on a pair of relays 250 on an EV side. In this case, a relay module 116 on a side of the DC distribution network facility 110, a charging facility, may also be turned on.

In the first rapid charging mode, the control unit 242 may charge the battery BAT by driving the inverter 220 using a buck converter.

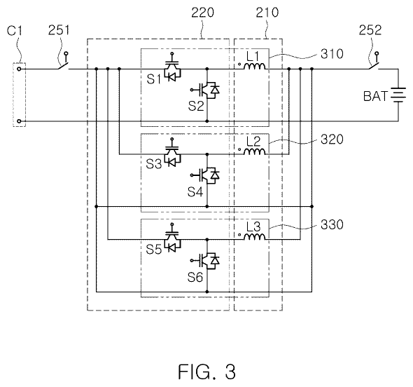

FIG. 3 is a diagram illustrating three buck converters.

As illustrated in FIG. 3, in the first rapid charging mode, the buck converter may include three buck converters 310, 320, and 330, rapidly charging the battery BAT, using the three stator coils L1, L2, and L3 included in the motor 210 as inductors.

Specifically, the buck converter may include a first buck converter 310 including a pair of switching elements S1 and S2 included in a first leg of the inverter 220 and a first stator coil L1 included in the motor 210, a second buck converter 320 including a pair of switching elements S3 and S4 included in a second leg of the inverter 220 and a second stator coil L2 included in the motor 210, and a third buck converter 330 including a pair of switching elements S5 and S6 included in a third leg of the inverter 220 and a third stator coil L3 included in the motor 210.

According to an example embodiment of the present disclosure, the control unit 242 may control the switching elements S1, S2, S3, S4, S5, and S6 in the first rapid charging mode to drive one of the first buck converter 310, the second buck converter 320, and the third buck converter 330.

Alternatively, according to another example embodiment of the present disclosure, the control unit 242 may control the switching elements S1, S2, S3, S4, S5, and S6 in the first rapid charging mode to (e.g., substantially) simultaneously drive at least two of the first buck converter 310, the second buck converter 320, and the third buck converter 330.

Alternatively, according to another embodiment of the present disclosure, the control unit 242 may control the switching elements S1, S2, S3, S4, S5, and S6 in an interleaved manner in the first rapid charging mode to drive at least two of the first buck converter 310, the second buck converter 320, and the third buck converter 330.

The interleaved manner may be a manner of sequentially driving at least two buck converters. For example, when three buck converters are driven in an interleaved manner, the three buck converters may be controlled with a phase difference of 120 degrees, and when the two buck converters are driven in an interleaved manner, the two buck converters may be controlled with a phase difference of 180 degrees.

When the rapid charging mode is the second rapid charging mode, the control unit 242 may control the mode change switch 230 to connect the (+) terminal of the battery BAT to the inverter 220.

Separately, the control unit 242 may turn on the pair of relays 250 on the EV side. In this case, a relay on a side of the rapid charging facility 120 (e.g., a charging facility) may also be turned on.

Thereafter, the battery BAT may be (e.g., directly) charged by the rapid charging facility 120.

When the rapid charging mode is the driving mode, the control unit 242 may control the mode change switch 230 to connect the (+) terminal of the battery BAT to the inverter 220.

Separately, the control unit 242 may turn off the pair of relays 250 on the EV side. In this case, relays on sides of the charging facilities 110 and/or 120 may also be turned off.

Finally, the storage unit 243 may store a program for implementing the above-described various functions of the control unit 242.

According to an example embodiment of the present disclosure, a rapid charging mode according to a connected charging facility may be determined, and a mode change switch may be controlled based on a result of the determination to allow change between rapid charging modes, such that a plurality of electric vehicles may be charged through a single large-capacity DC distribution network facility, thereby reducing costs for installation of a charging facility and having compatibility with an existing rapid charging facility.

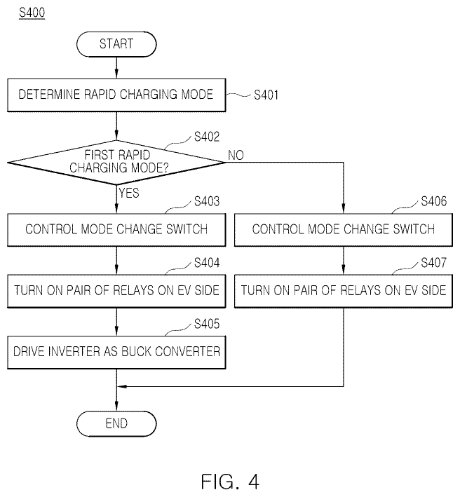

FIG. 4 is a flowchart illustrating a method of controlling rapid charging of an electric vehicle according to an example embodiment of the present disclosure.

Hereinafter, a method of controlling rapid charging of an electric vehicle according to an example embodiment of the present disclosure will be described with reference to FIGS. 1 to 4. However, for simplicity of the present disclosure, descriptions overlapping those of FIGS. 1 to 3 will be omitted.

Referring to FIGS. 1 to 4, a method (S400) of controlling rapid charging of an electric vehicle according to an example embodiment of the present disclosure may be started by an operation of determining a rapid charging mode according to a charging facility (S401).

Specifically, an electric vehicle 200 may receive a flag signal from charging facilities 110 and/or 120, and may determine, based on the received flag signal, a rapid charging mode.

The rapid charging mode may include a first rapid charging mode in which a connected charging facility is a DC distribution network facility 110 and a second rapid charging mode in which the charging facility is a rapid charging facility 120. For example, the flag signal may be “1” when the charging facility is the DC distribution network facility 110, and the flag signal may be “0” when the charging facility is the rapid charging facility 120, as described above.

Thereafter, the electric vehicle 200 may control, based on a result of the determination, a mode change switch to change from a first rapid charging mode to a second rapid charging mode or from the second rapid charging mode to the first rapid charging mode (S401 and S406).

Here, a mode change switch 230 may be a three-way switch, a first terminal and a second terminal of the three-way switch may be connected to a space between a (+) terminal of a battery BAT and an inverter 220, and a third terminal of the three-way switch may be connected to a neutral point of stator coils L1, L2, and L3 included in a motor 210, as described above.

Specifically, when the rapid charging mode determined in operation S401 is the first rapid charging mode (S402), the electric vehicle 200 may control the mode change switch 230 to disconnect the (+) terminal of the battery BAT and the inverter 220 from each other, and may connect the (+) terminal of the battery BAT to the neutral point of the stator coils L1, L2, and L3 included in the motor 210 (S403).

Thereafter, the electric vehicle 200 may turn on a pair of relays 250 on an EV side (S404). In this case, a relay module 116 on a side of the DC distribution network facility 110, a charging facility, may also be turned on as described above.

Thereafter, the electric vehicle 200 may charge the battery BAT by driving the inverter 220 using a buck converter (S405).

Specifically, the buck converter may include three buck converters 310, 320, and 330, rapidly charging the battery BAT, using the three stator coils L1, L2, and L3 included in the motor 210 as inductors.

Specifically, the buck converter may include a first buck converter 310 including a pair of switching elements S1 and S2 included in a first leg of the inverter 220 and a first stator coil L1 included in the motor 210, a second buck converter 320 including a pair of switching elements S3 and S4 included in a second leg of the inverter 220 and a second stator coil L2 included in the motor 210, and a third buck converter 330 including a pair of switching elements S5 and S6 included in a third leg of the inverter 220 and a third stator coil L3 included in the motor 210.

Thereafter, the electric vehicle 200 may control the switching elements S1, S2, S3, S4, S5, and S6 in the first rapid charging mode to drive one of the first buck converter 310, the second buck converter 320, and the third buck converter 330.

Alternatively, the electric vehicle 200 may (e.g., substantially) simultaneously drive at least two of the first buck converter 310, the second buck converter 320, and the third buck converter 330 by controlling the switching elements S1, S2, S3, S4, S5, and S6 in the first rapid charging mode.

Alternatively, the electric vehicle 200 may control the switching elements S1, S2, S3, S4, S5 and S6 in an interleaved manner in the first rapid charging mode to drive at least two of the first buck converter 310, the second buck converter 320, and the third buck converter 330. The interleaved manager may be a manner of sequentially driving at least two buck converters, as described above.

Conversely, when the rapid charging mode is not the first rapid charging mode (S402), the electric vehicle 200 may control the mode change switch 230 to connect the (+) terminal of the battery BAT to the inverter 220 (S406).

Thereafter, the electric vehicle 200 may turn on the pair of relays 250 on the EV side (S407). In this case, the relay on the rapid charging facility 120 may also be turned on as described above.

When the rapid charging mode is the driving mode, the electric vehicle 200 may control the mode change switch 230 to connect the (+) terminal of the battery BAT to the inverter 220. Separately, the pair of relays 250 on the EV side may be turned off. In this case, relays on sides of the charging facilities 110 and/or 120 may also be turned off, as described above.

According to an example embodiment of the present disclosure, a rapid charging mode according to a connected charging facility may be determined, and a mode change switch may be controlled based on a result of the determination to allow change between rapid charging modes, such that a plurality of electric vehicles may be charged through a single large-capacity DC distribution network facility, thereby reducing costs for installation of a charging facility and being compatible with an existing rapid charging facility.

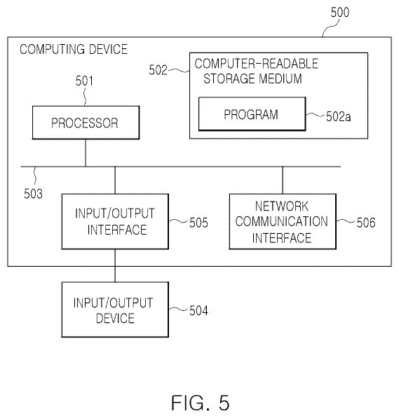

FIG. 5 is a block diagram of a computing device 500 capable of fully or partially implementing a control module 240 included in an electric vehicle 200 according to an example embodiment of the present disclosure.

As illustrated in FIG. 5, the computing device 500 may include at least one processor 501, a computer-readable storage medium 502, and a communication bus 503.

The processor 501 may cause the computing device 500 to operate according to the example embodiments described above. For example, the processor 501 may execute one or more programs stored in the computer-readable storage medium 502. The one or more programs may include one or more computer-executable instructions. When executed by the processor 501, the one or more computer-executable instructions may be configured to cause the computing device 500 to perform operations according to example embodiments.

The computer-readable storage medium 502 may be configured to store the computer-executable instructions or program code, program data, and/or other suitable forms of information. A program 502a, stored in the computer-readable storage medium 502, may include a set of instructions executable by the processor 501. In an example embodiment, the computer-readable storage medium 502 may be a memory (a volatile memory such as a random access memory, a non-volatile memory, or any suitable combination thereof), one or more magnetic disk storage devices, optical disk storage devices, flash memory devices, other types of storage media that are accessible by the computing device 500 and are capable of storing desired information, or any suitable combinations thereof.

The communication bus 503 may interconnect various other components of the computing device 500, including the processor 501 and the computer-readable storage medium 502.

The computing device 500 may also include one or more input/output interfaces 505 providing an interface for one or more input/output devices 504, and one or more network communication interfaces 506. The input/output interface 505 and the network communication interface 506 may be connected to the communication bus 503. A network may be one of a cellular network, for example, a global system for mobile communications (GSM), an enhanced data rate for GSM evolution (EDGE), a general packet radio service (GPRS), a code division multiple access (CDMA), a time division-CDMA (TD-CDMA), a universal mobile telecommunications system (UMTS), or long-term evolution (LTE), or another cellular network.

The input/output device 504 may be connected to other components of the computing device 500 through the input/output interface 505. The exemplary input/output device 504 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 504 may be included in the computing device 500 as a component included in the computing device 500, or may be connected to the computing device 500 as a device, distinct from the computing device 500.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the example embodiments, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While example embodiments have been shown and described above, it will be apparent to those skilled in the art that modifications and variations could be made without departing from the scope of the present disclosure as defined by the appended claims.

What is claimed is:

1. An electric vehicle comprising:
a battery;
a motor;
an inverter;
a mode change switch; and
a control module, wherein the control mode includes:
one or more processors; and
a storage medium storing a computer-readable instruction,
when the computer-readable instruction is executed by one or more processors, the one or more processors are configured to:
determine a rapid charging mode according to a connected charging facility, the rapid charging mode including a first rapid charging mode when the charging facility is a DC distribution network facility and a second rapid charging mode when the charging facility is a rapid charging facility; and
control, based on a result of the determination, the mode change switch to change from the first rapid charging mode to the second rapid charging mode or from the second rapid charging mode to the first rapid charging mode.

2. The electric vehicle of claim 1, wherein
the mode change switch is a three-way switch,
a first terminal and a second terminal of the three-way switch are connected between a (+) terminal of the battery and the inverter, and
a third terminal of the three-way switch is connected to a neutral point of a stator coil included in the motor.

3. The electric vehicle of claim 1, wherein the one or more processors are configured to perform, based on a flag received from the connected charging facility, the determination.

4. The electric vehicle of claim 2, wherein, when the rapid charging mode is the first rapid charging mode, the one or more processors are configured to control the mode change switch to disconnect the (+) terminal of the battery and the inverter from each other, and to connect the (+) terminal of the battery to the neutral point of the stator coil included in the motor.

5. The electric vehicle of claim 4, further comprising:
a pair of relays on an EV side provided on an input side,
wherein the one or more processors are configured to turn on the pair of relays on the EV side.

6. The electric vehicle of claim 2, wherein the one or more processors are configured to drive the inverter as a buck converter in the first rapid charging mode.

7. The electric vehicle of claim 6, wherein the buck converter includes three buck converters, rapidly charging the battery, using three stator coils included in the motor as inductors in the first rapid charging mode.

8. The electric vehicle of claim 6, wherein the buck converter includes:
a first buck converter including a pair of switching elements included in a first leg of the inverter, and a first stator coil included in the motor;
a second buck converter including a pair of switching elements included in a second leg of the inverter, and a second stator coil included in the motor; and
a third buck converter including a pair of switching elements included in a third leg of the inverter, and a third stator coil included in the motor.

9. The electric vehicle of claim 8, wherein the one or more processors are configured to:
drive one of the first buck converter, the second buck converter, and the third buck converter in the first rapid charging mode;
simultaneously drive at least two of the first buck converter, the second buck converter, and the third buck converter in the first rapid charging mode; and
drive at least two of the first buck converter, the second buck converter, and the third buck converter in an interleaved manner in the first rapid charging mode.

10. The electric vehicle of claim 2, wherein, when the rapid charging mode is the second rapid charging mode, the one or more processors are configured to control the mode change switch to connect the (+) terminal of the battery to the inverter.

11. The electric vehicle of claim 10, further comprising:
a pair of relays on an EV side provided on an input side,
wherein the one or more processors are configured to turn on the pair of relays on the EV side.

12. The electric vehicle of claim 1, wherein
the DC distribution network facility includes:
a three-winding transformer configured to convert three-phase AC power into first AC power according to Y-Y connection, and to convert the three-phase AC power into second AC power through Y-Delta connection;
a first rectifier configured to rectify the converted first AC power; and
a second rectifier configured to rectify the converted second AC power, and
an output of the first rectifier and an output of the second rectifier are connected to each other in parallel.

13. The electric vehicle of claim 1, wherein
one electric vehicle is connectable to the rapid charging facility, and
a plurality of electric vehicles are connectable to the DC distribution network facility.

14. A method of controlling rapid charging of an electric vehicle including a motor, a battery, an inverter, and a mode change switch, the method comprising:
a first operation of determining a rapid charging mode according to a connected charging facility, the rapid charging mode including a first rapid charging mode when the charging facility is a DC distribution network facility and a second rapid charging mode when the charging facility is a rapid charging facility; and
a second operation of controlling, based on a result of the determination, the mode change switch to change from the first rapid charging mode to the second rapid charging mode or from the second rapid charging mode to the first rapid charging mode.

15. The method of claim 14, wherein
the mode change switch is a three-way switch,
a first terminal and a second terminal of the three-way switch are connected between a (+) terminal of the battery and the inverter, and
a third terminal of the three-way switch is connected to a neutral point of a stator coil included in the motor.

16. The method of claim 14, wherein the first operation includes performing, based on a flag received from the connected charging facility, the determination.

17. The method of claim 15, wherein
when the rapid charging mode is the first rapid charging mode, the second operation includes controlling the mode change switch to disconnect the (+) terminal of the battery and the inverter from each other, and to connect the (+) terminal of the battery to the neutral point of the stator coil included in the motor, and
when the rapid charging mode is the second rapid charging mode, the second operation includes controlling the mode change switch to connect the (+) terminal of the battery to the inverter.

18. The method of claim 15, further comprising:
an operation of driving the inverter as a buck converter in the first rapid charging mode,
wherein the buck converter includes three buck converters including a first buck converter, a second buck converter, and a third buck convertor, rapidly charging the battery, using three stator coils included in the motor as inductors in the first rapid charging mode.

19. The method of claim 18, further comprising:
an operation of driving one of the first buck converter, the second buck converter, and the third buck converter in the first rapid charging mode;
an operation of simultaneously driving at least two of the first buck converter, the second buck converter, and the third buck converter in the first rapid charging mode; and
an operation of driving at least two of the first buck converter, the second buck converter, and the third buck converter in an interleaved manner in the first rapid charging mode.

20. The method of claim 14, wherein
a plurality of electric vehicles are connectable to the DC distribution network facility in parallel, and
one electric vehicle is connectable to the rapid charging facility.
